(19) United States
(12) Patent Application Publication
(10) Pub. No.: US 2026/0161528 A1
(43) Pub. Date: Jun. 11, 2026

(54) CATEGORIZED INPUT/OUTPUT RANKINGS

(71) Applicant: INTERNATIONAL BUSINESS MACHINES CORPORATION, ARMONK, NY (US)

(72) Inventors: Franco Vincent Borich, Naperville, IL (US); Scott Horan, DuPage, IL (US); Adam Gray, Chicago, IL (US)

(21) Appl. No.: 18/970,989

(22) Filed: Dec. 6, 2024

(51) Int. Cl. G06F 11/34

(52) U.S. Cl. CPC G06F 11/3485; G06F 11/3433

(57) ABSTRACT

Systems and methods are provided for categorizing input/output rankings. Data in storage devices is categorized by data type and performance related characteristics of that data. All operation types are identified that are performed on the categorized data. A ranking is created for each data type by storage device. The ranking indicates the preferred storage devices for optimal performance. The rankings are stored as a map in one or more access devices. Upon receiving an input/output operation request, a storage device is selected based on the ranking in the map.

### BACKGROUND

This invention relates generally to computer systems, and more particularly to categorized Input/Output (I/O) rankings.

Cloud object storage (COS) is a type of distributed storage system that is becoming a preferred method for application data processing, as well as for data archiving and backup. COS has the advantage over more traditional files and block data storage at least because, in addition to improved reliability, extensibility, and security, the application accesses COS directly by making a request by object name to an accessor node. The object is stored in a structurally flat data environment, e.g., a namespace, with other objects. This relieves the application from the responsibility of data management tasks.

In the distributed storage system data is stored on multiple devices. Each device may store multiple types of data that can be categorized by performance characteristics. I/O performance is often determined by a subset of devices because the distributed system often employs a consensus protocol that does not require an agreement from all nodes in the system for an I/O operation. In current technology, only a single ranking is stored for different data types for use in accessing data. Data types vary depending on use, such as physical disk, solid state drive (SSD), optical, etc. Since data types can have different performance characteristics a single ranking used for devices often leads to suboptimal choice for an IO operation, wasted resources associated with subsequent additional operations that could have been prevented, and underutilization of resources under certain circumstances.

It would be advantageous to improve distributed storage systems by storing multiple independent rankings by data type, thereby avoiding the side effects of selecting devices using a single per-device ranking.

### SUMMARY

Systems and methods are provided for categorizing input/output rankings. Data in storage devices is categorized by data type and performance related characteristics of that data. All operation types are identified that are performed on the categorized data. A ranking is created for each data type by storage device. The ranking indicates the preferred storage devices for optimal performance. The rankings are stored as a map in one or more access devices. Upon receiving an input/output operation request, a storage device is selected based on the ranking in the map.

### BRIEF DESCRIPTION OF THE SEVERAL VIEWS OF THE DRAWINGS

Embodiments are further directed to computer systems and computer program products having substantially the same features as the above-described computer-implemented method.

FIG. 1 illustrates the operating environment of a computer system in which a Cloud Object Storage (COS), i.e., distributed storage system is installed;

FIG. 2 is high level block diagram of a COS distributed storage system having single ranking of storage devices;

FIG. 3 is a high-level block diagram of a COS distributed storage system having multiple rankings of storage devices; and

FIG. 4 illustrates an exemplary flow chart of embodiments of the present invention.

### DETAILED DESCRIPTION OF THE INVENTION

COS is a distributed storage system (DSS) that uses several storage nodes to store data objects across the available nodes. COS uses various ranking algorithms to break the data objects into encoded and encrypted slices that are then distributed to the devices on the storage nodes. Using a consensus protocol, I/O operations may be satisfied by only a subset of all the devices on which the data is stored. Each of the devices may store multiple types of data, each of which may have different performance characteristics.

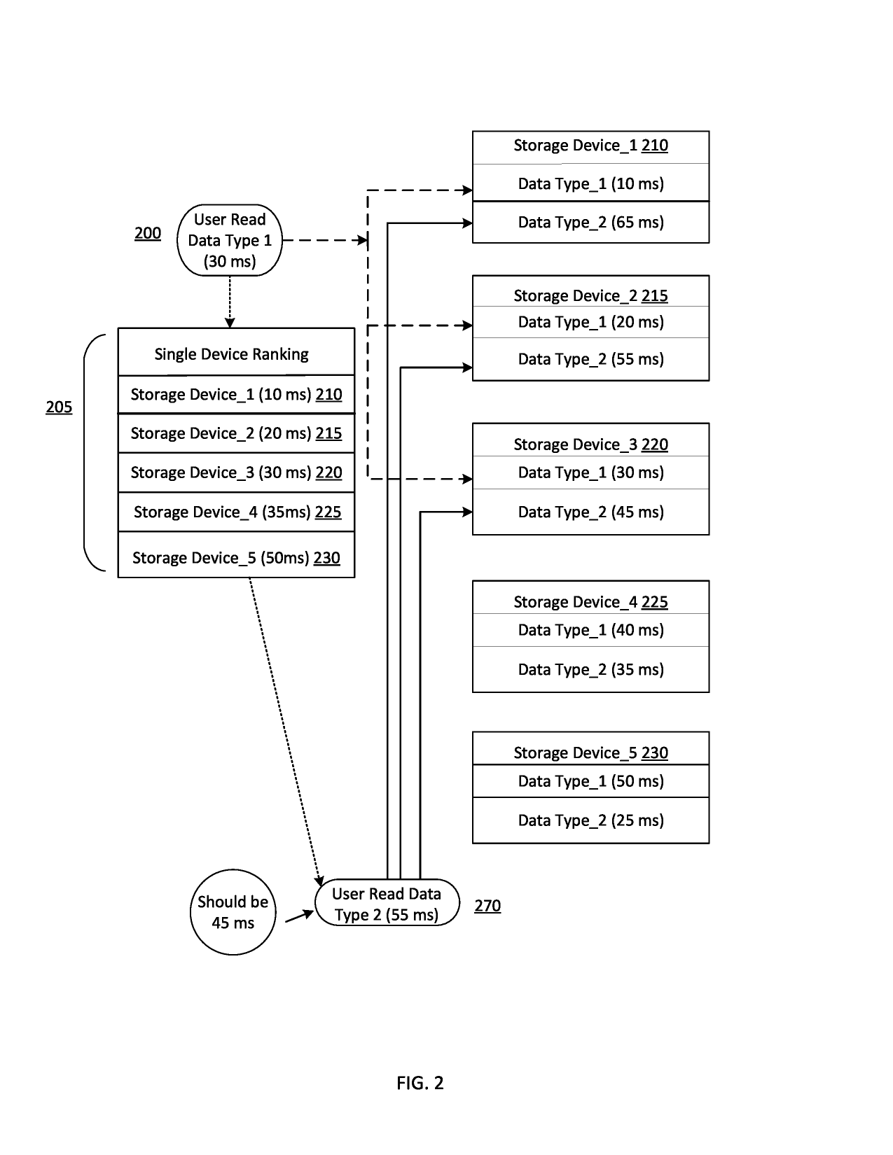

As discussed below with reference to FIG. 2, in current practice storing only a single ranking in an accesser device for all data types may negatively impact performance by selecting a slower device or causing a timeout when one of the preferred devices is unavailable. The COS/DSS environment is complex, often including multiple interconnected geographies, nodes, and networks, making it difficult and time consuming for systems administrators to improve performance using data placement on devices. Storing single device rankings in the accesser device may be inherent in the architecture of a particular COS or DSS, and therefore beyond the systems administrator’s ability to improve.

Usually, to overcome the performance drawbacks of single per-device ranking, the customer adds hardware resources, or reiteratively attempts to tune the system to increase performance. Both approaches are expensive, time consuming, and may not return results commensurate with the effort. As another example, some architectures use an internal lifecycle where data is initially stored on the fastest devices and aged to slower devices. Such a configuration only considers a limited set of data characteristics, such as access frequency, but omits other considerations, such as data type which is needed to select the best device for data placement.

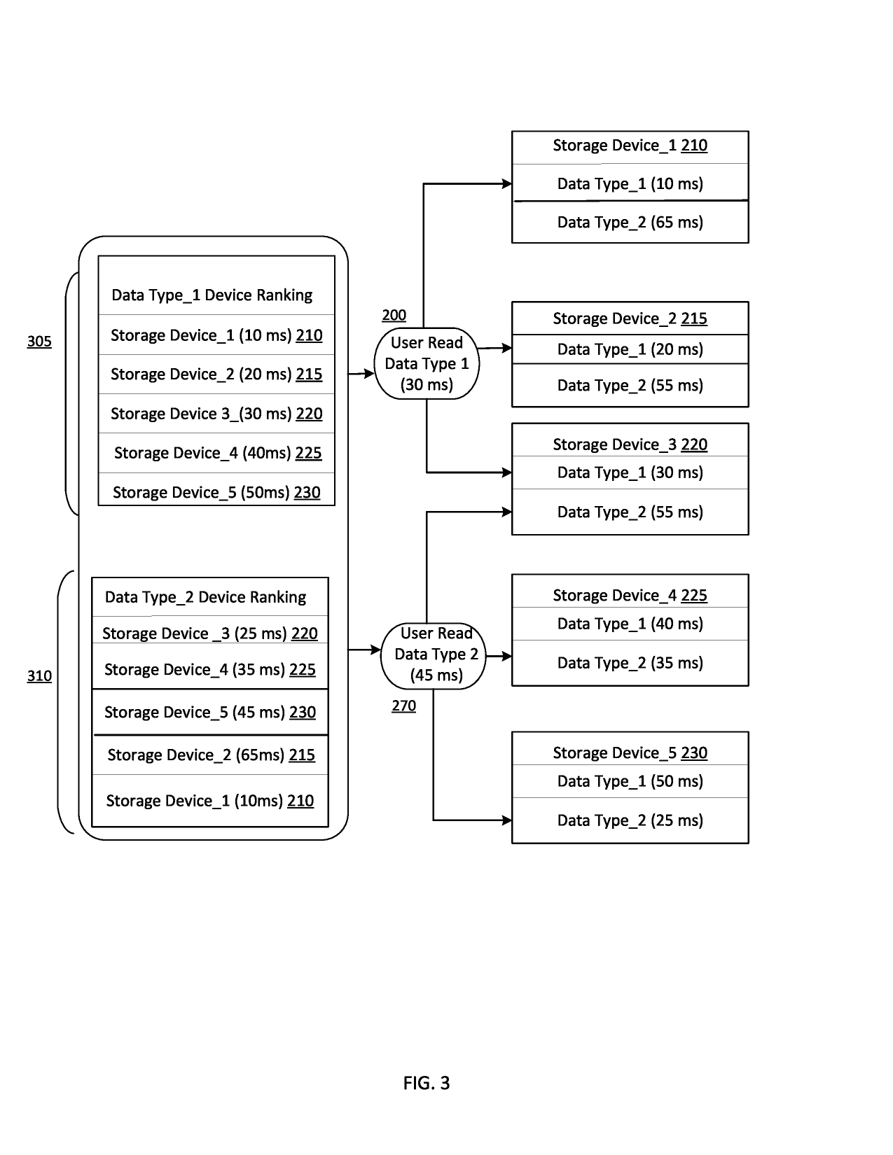

Embodiments of the present invention address the drawbacks of the current technology by storing multiple independent device rankings for each known data type in the accessor device. This allows for selecting optimal devices for I/O operations in a distributed system, as discussed below with reference to FIG. 3.

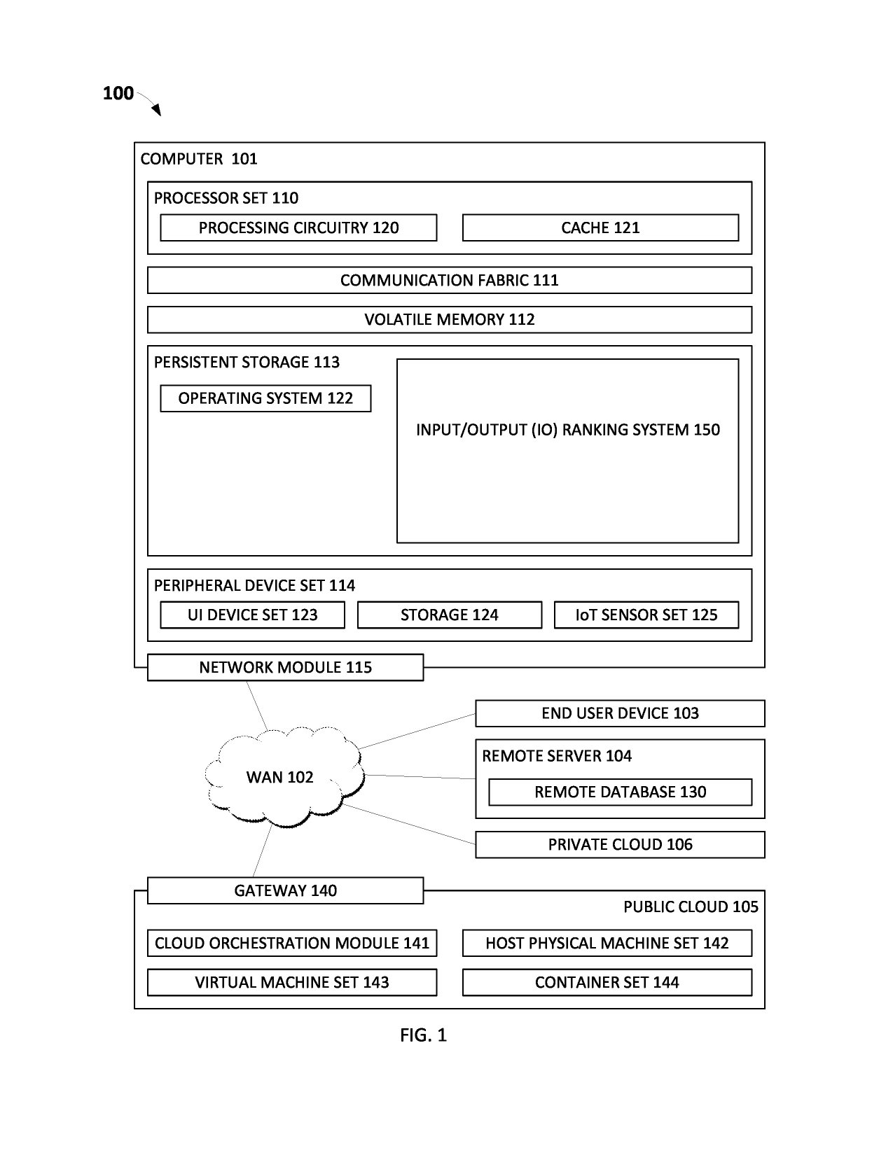

Turning now to FIG. 1, a block diagram of the operating environment of a computer system in which embodiments of the present invention for categorizing I/O rankings is installed.

Computing environment 100 contains an example of an environment for the execution of at least some of the computer code involved in performing the inventive methods of categorizing I/O rankings (ranking system) 150.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, an administrator that operates computer 101), and may take any of the forms discussed above in connection with computer 101. For example, EUD 103 can be the external application by which an end user connects to the control node through WAN 102. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Referring now to FIG. 2, a high-level block diagram of COS distributed storage system having single ranking of storage devices is shown.

The accesser device 205 stores the device rankings in its memory for all the data types on the devices to which the accesser device 205 is connected. Here, storage device_1 210, storage device_2 215, storage device_3 220, storage device_4 225, and storage device_5 230 are connected to the accesser device 205. The millisecond (ms) values shown are for the device without regard to the data type on the particular storage device, as tracked by historical performance data. For example, the latency for storage device_1 210 is 10ms, for storage device_2 215 the latency is 20ms, for storage device_3 the latency is 30ms, for storage device_4 the latency is 35ms and for storage device_5 the latency is 50ms. There may be multiple accesser devices 205 either directly connected or network connected to the storage devices, also referred to as nodes. The accesser devices 205 are independent from each other and each one includes the latency values for the devices to which it is directly connected. Not shown in the figure is a gateway/load balancer device that selects the accesser device 205 to which the incoming I/O operation is directed.

In the example, at 200 the user issues a generic read operation for data type_1. The device ranking in the accesser device 205 memory is based on historical performance data for each of the connected storage devices, without regard to the particular data type being stored thereupon. The consensus algorithm in the accesser device 205 selects storage device_1 210, storage device_2 215, and storage device_3 220 for the I/O operation. However, these may not be the best possible devices for the particular data type. If one of the selected storage devices is unavailable, the I/O operation can time out, requiring it to be reissued to one or more of the other connected storage devices. This could result in a cascading degradation, which is a failure in the cloud that grows over time, such as a resource overload.

As a further example, at 270 the user issues a generic read, this time for data type_2. Similarly, there is a single device ranking in the accesser device 205 memory for all the connected storage devices without regard to data type. The consensus algorithm in the accesser device 205 again selects storage device_1 210, storage device_2 215 and storage device_3 220 for the I/O operation, even though another combination of storage devices would produce less latency for the particular data type_2.

Referring now to FIG. 3, a high-level block diagram of COS distributed storage system showing a portion of the memory of one accesser device 205. The accesser device 205 memory stores separate rankings of storage devices for each data type stored thereupon. There can be multiple separate rankings in the accesser device 205, one for each data type stored on the storage devices connected to the accesser device 205. In this example, there are two data types. The ranking for data type_1 is shown as the map of 305. The ranking for data type_2 is shown as the map 310. The view of each accessor device 205 is different from the others in the ranking system 150 because they each go to different devices and have different observation of devices and their performance.

As in FIG. 2, at 200 the user issues a generic read operation for data type_1. Similarly, the consensus algorithm in the accesser device 205 selects storage device_1 210, storage device_2 215, and storage device_3 220 for the I/O operation. There may not be historical performance data to support different device rankings for data type_1 from those shown in FIG. 2.

As a further example, at 270 the user issues a generic read, this time for data type_2. However, there is a separate device ranking for data type_2, in the accesser device 205 memory for all the connected storage devices. This time, the consensus algorithm in the accesser device 205 selects storage device_3 220, storage device_4 225 and storage device_5 230 for the I/O operation.

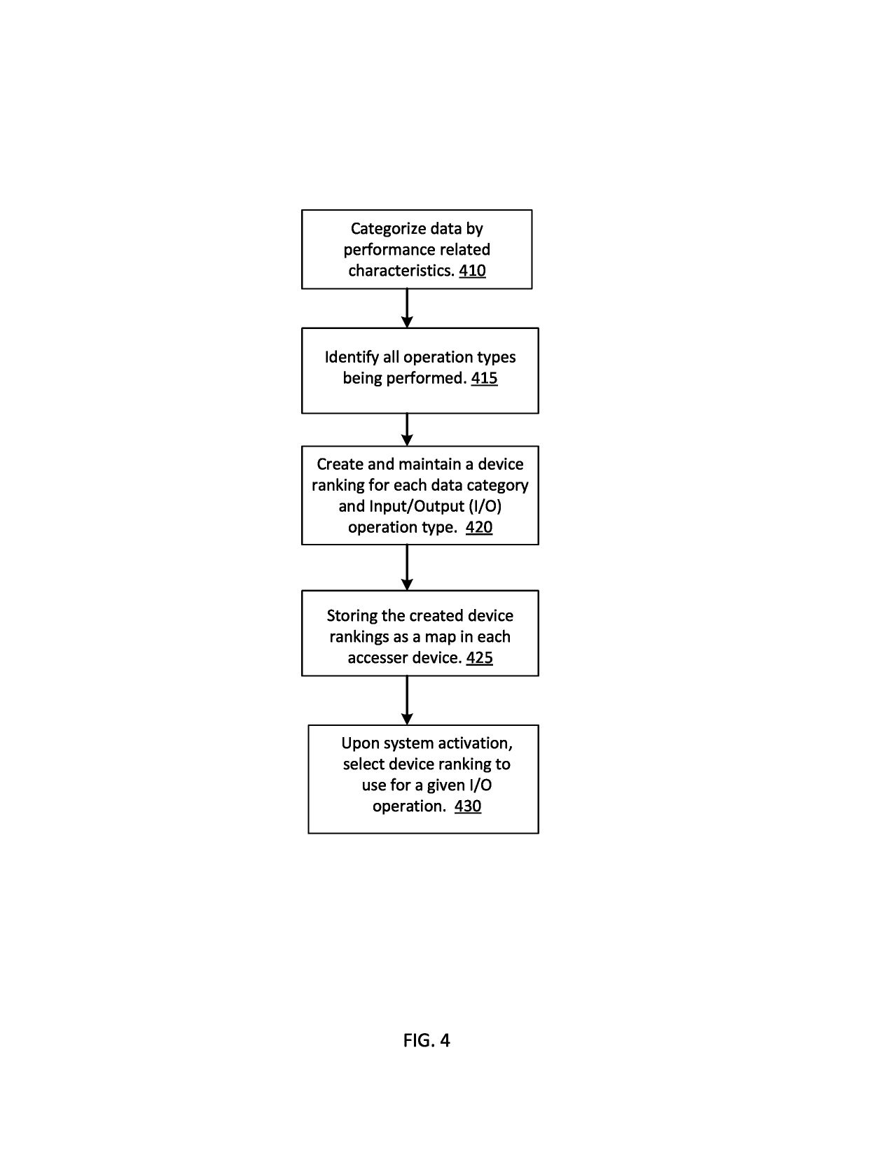

FIG. 4 illustrates an exemplary flow chart of embodiments of the present invention.

At 410 at activation the ranking system 150 categorizes data on the connected storage devices by performance related characteristics.

All possible data categories in the ranking system 150 are grouped by their different performance characteristics, including all storage media types used by devices in system 150, e.g., the device inventory. All well-defined lifecycles that exist in the data are identified. For example, certain data types (smaller short-lived amounts of data) may produce higher cache hits. Similarly, all levels of data mutability are identified. The mutability characteristic refers to whether the data object can be accessed and changed after their creation. Frequency patterns of data access, i.e., read, delete, update, influence storage device selection and placement. The requirements for data consistency refer to the state of data in which all copies or instances are the same across all systems and databases. The data durability requirement refers to the ability of stored data to remain intact, complete, and uncorrupted over time.

The categorizing discovery happens automatically upon activation of the system 150. The result is stored in a map of the topology of the ranking system 150. Each accesser device 205 has its own view of the devices and their performance, which is a view different from that of the other accesser devices 205 since each accesser device 205 has different device connectivity.

A customer with specific workload requirements may affect one or more of the above data requirement categories either manually or programmatically, using any number of known stress testing techniques. However, attempts to influence the ranking system 150 should be carefully based on a high level of knowledge, at least of the applications, their data access patterns, data types, and any service level agreements.

At 415, the ranking system 150 identifies all operation types being performed. This is simply the system 150 identifying the I/O operations (e.g., opcodes) being performed.

At 420, the ranking system 150 creates and maintains a device ranking for each data category and I/O operation type. In 420, the ranking system 150 initializes a historical data ranking for each data category (date type) and operation type (read/write/delete), using the ranking system 150 algorithm. As the operations are performed, the corresponding historical data ranking is updated.

At 425, the ranking system 150 stores the created device rankings as a map in each accessor device. As described above, each accesser device 205 receives a map corresponding to its own view of the connected devices and their performance.

At 430 at system activation, the ranking system 150 receives request for an I/O operation, which it forwards to an accesser device 205. The accesser device 205 may be selected by a load balancer, or by other similar devices. Using the map stored in its memory, the selected accesser device 205 determines the I/O request and data type by examining the request. Based on the data type and operation type, the accesser device 205 directs the I/O operation to the highest ranked device for the operation.

As may be used herein, the terms “substantially” and “approximately” provide an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to.” As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with,” includes direct and/or indirect coupling of separate items and/or one item being embedded within another item.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules, and components herein, can be implemented as illustrated or by discrete components, application specific integrated circuits, processors executing appropriate software and the like or any combination thereof.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from Figure to Figure, the embodiments may incorporate the same or similarly named functions, steps, modules, etc. that may use the same or different reference numbers and, as such, the functions, steps, modules, etc. may be the same or similar functions, steps, modules, etc. or different ones.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid-state memory, a hard drive memory, cloud memory, thumb drive, server memory, computing device memory, and/or other physical medium for storing digital information. A computer readable memory/storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method comprising:
categorizing data by data type on a plurality of storage devices by performance related characteristics;
identifying all operation types being performed on the categorized data;
creating a ranking for each data type by storage device, wherein the ranking indicates a preferred storage devices for optimal performance;
storing the created ranking as a map in one or more accesser devices; and
upon receiving an I/O operation request, selecting a storage device based on the ranking in the map.

2. The method of claim 1, wherein the performance related characteristics are gathered based on historical performance data.

3. The method of claim 1, wherein the one or more accessor devices each store a map for the storage devices to which the one or more accessor device is directly connected.

4. The method of claim 1, wherein the one or more accessor devices are independent from each other, and wherein one of the one or more storage devices can access storage devices from another accessor device.

5. The method of claim 1, wherein ranking for each data type is by the performance characteristics of the data type.

6. The method of claim 1, wherein each data type is grouped by their performance requirements in the map in each of the accesser devices.

7. The method of claim 1, wherein each of the accessor devices are connected through a gateway load balancer, wherein the load balancer directs an incoming I/O operation.

8. A computer program product, the computer program product comprising a non-transitory tangible storage device having program code embodied therewith, the program code executable by a processor of a computer to perform a method, the method comprising:
categorizing data by data type on a plurality of storage devices by performance related characteristics;
identifying all operation types being performed on the categorized data;
creating a ranking for each data type by storage device, wherein the ranking indicates a preferred storage devices for optimal performance;
storing the created ranking as a map in one or more accesser devices; and
upon receiving an I/O operation request, selecting a storage device based on the ranking in the map.

9. The computer program product of claim 8, wherein the performance related characteristics are gathered based on historical performance data.

10. The computer program product of claim 8, wherein the one or more accessor devices each store a map for the storage devices to which the one or more accessor device is directly connected.

11. The computer program product of claim 8, wherein the one or more accessor devices are independent from each other, and wherein one of the one or more storage devices can access storage devices from another accessor device.

12. The computer program product of claim 8, wherein ranking for each data type is by the performance characteristics of the data type.

13. The computer program product of claim 8, wherein each data type is grouped by their performance requirements in the map in each of the accesser devices.

14. A computer system the computer system, comprising:
one or more processors;
a memory coupled to at least one of the processors;
a set of computer program instructions stored in the memory and executed by at least one of the processors in order to perform actions of:
categorizing data by data type on a plurality of storage devices by performance related characteristics;
identifying all operation types being performed on the categorized data;
creating a ranking for each data type by storage device, wherein the ranking indicates a preferred storage devices for optimal performance;
storing the created ranking as a map in one or more accesser devices; and
upon receiving an I/O operation request, selecting a storage device based on the ranking in the map.

15. The computer system of claim 14, wherein the performance related characteristics are gathered based on historical performance data.

16. The computer system of claim 14, wherein the one or more accessor devices each store a map for the storage devices to which the one or more accessor device is directly connected.

17. The computer system of claim 14, wherein the one or more accessor devices are independent from each other, and wherein one of the one or more storage devices can access storage devices from another accessor device.

18. The computer system of claim 14, wherein ranking for each data type is by the performance characteristics of the data type.

19. The computer system of claim 14, wherein each data type is grouped by their performance requirements in the map in each of the accesser devices.

20. The computer system of claim 14, wherein each of the accessor devices are connected through a gateway load balancer, wherein the load balancer directs an incoming I/O operation.
